(19) United States
(12) Patent Application Publication
(10) Pub. No.: US 2025/0365359 A1
(43) Pub. Date: Nov. 27, 2025

(54) ACCESSORY MOUNT

(71) Applicant: PREMIER ACCESSORY GROUP LLC, Cranbury, NJ (US)

(72) Inventors: Alfred Esses, Brooklyn, NY (US); Andrew Skurdal, Westfield, NJ (US)

(21) Appl. No.: 19/217,794

(22) Filed: May 23, 2025

Related U.S. Application Data
(63) Continuation of application No. 29/943,680, filed on May 23, 2024.
(60) Provisional application No. 63/739,998, filed on Dec. 30, 2024.

(51) Int. Cl. H04M 1/04

(52) U.S. Cl. CPC H04M 1/04

(57) ABSTRACT

An accessory mount, and more specifically to a phone mount that is configured to secure the phone to the mount with a whole-body trigger allowing for one-handed grip.

### CROSS-REFERENCE TO RELATED APPLICATION

This patent application claims benefit to U.S. Design Patent Application No. 29/943,680, filed May 23, 2024 and U.S. Provisional Patent Application No. 63/739,998, filed Dec. 30, 2024, which are hereby incorporated by reference in their entirety as part of the present disclosure.

### FIELD OF THE INVENTION

The present disclosure generally relates generally to an accessory mount, and more specifically to a phone mount that is configured to secure the phone to the mount with a whole-body trigger allowing for one-handed grip.

### BACKGROUND

In general, mounts for phones are well-known. However, no phone mount is configured to secure a phone thereto with a whole-body trigger allowing for one-handed grip.

### SPECIFICATION

In an embodiment, the present disclosure is directed to a phone mount that is configured to secure a phone thereto with a whole-body trigger allowing for one-handed grip.

The phone mount can generally include a housing comprising a main body, a cover plate 16 fixable to the main body, a pad that is configured to extend over the cover plate and be fixable thereto, a first arm, a second arm, a moveable plate, a first spring, a second spring and a third spring and a foot rest. The springs are compression springs. The first arm and the second arm are configured such that one of the arms can extend over the other of the arms.

In a non-use state, the contact arm of the first arm and the contact arm of the second arm are spaced away from each other. The legs are contacted substantially within the cavity and in turn, the release arm and the release arm are in close proximity to the main body and between the contact arms. The first spring and the second spring are in a compressed state. The third spring is in contact with the moveable plate with the moveable plate in contact with the main body such that a gap does not exist between the moveable plate and the main body. By being in contact with the main body, the arms are prohibited from moving toward each other.

In a use state, the pad and in turn cover plate are contacted by a force (e.g. the back a phone). The force acts as a trigger to cause the moveable plate to move away from the main which in turn allows the first arm and the second arm to move toward each other with the aid of the first spring band the second spring to provide forces to the arms. The base of the first arm slides under the moveable plate with the recess contacting the base of the moveable plate and the sidewalls of the arm aiding to guide and partially encompass the moveable plate and the base of the second arm slides under the moveable plate with the recess contacting the base of the moveable plate and the sidewalls of the arm aiding to guide and partially encompass the moveable plate. When the arms are in a contracted or use state, the arm can secure a phone in place by exerting a force on each side of the phone.

To release a phone from the arms, a user can use one-hand contact and apply a force to the outer surface of the release arm and the release arm. This in turn causes the contact arm and the contact arm to become spaced away from or disengaged from the phone or device. When the release arms are fully contracted and the contact arms are fully spaced from each other, the moveable plate can move toward the inner surface of the main body and prevent the contact arms from moving toward each other.

### BRIEF DESCRIPTION OF THE DRAWINGS

FIG. 1 is front exploded view of a phone mount according to an embodiment of the present disclosure;

FIG. 2 is rear exploded view of the phone mount according to an embodiment of the present disclosure;

FIG. 3 is a front perspective view of the phone mount according to an embodiment of the present disclosure;

FIG. 4 is a rear perspective view of the phone mount according to an embodiment of the present disclosure;

FIG. 5 is a front view of the phone mount according to an embodiment of the present disclosure;

FIGS. 6 and 7 are a front perspective views of the phone mount with portions thereof removed according to an embodiment of the present disclosure;

FIG. 8 is an assembly view of the phone mount according to an embodiment of the present disclosure; and

FIGS. 9-13 are various views of the phone mount with portions thereof removed according to an embodiment of the present disclosure.

### DETAILED DESCRIPTION OF EMBODIMENTS OF THE INVENTION

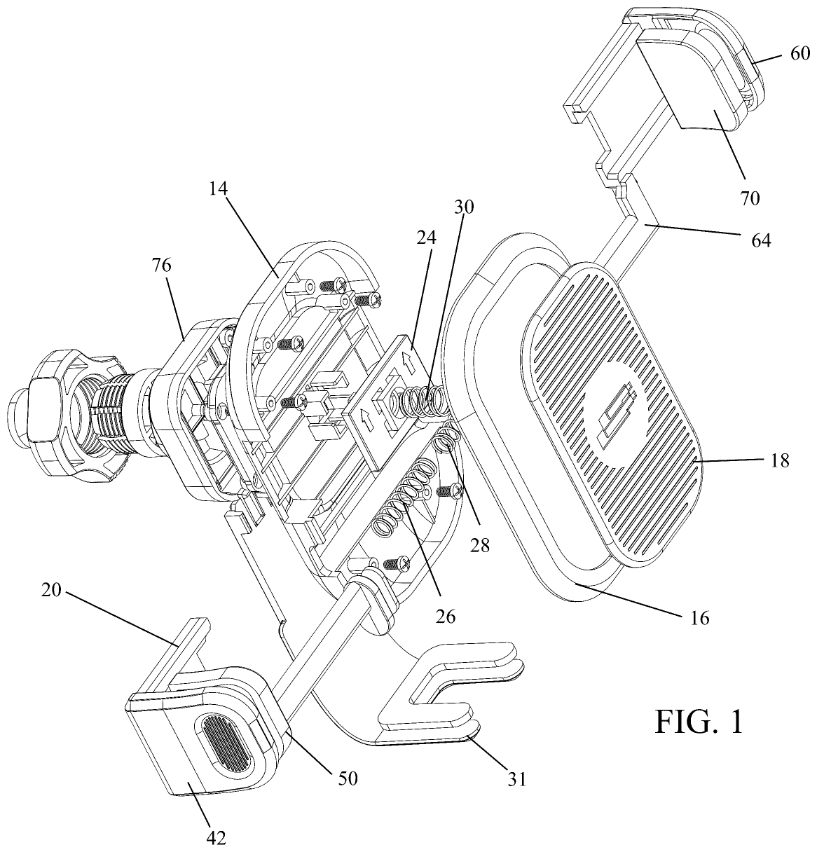

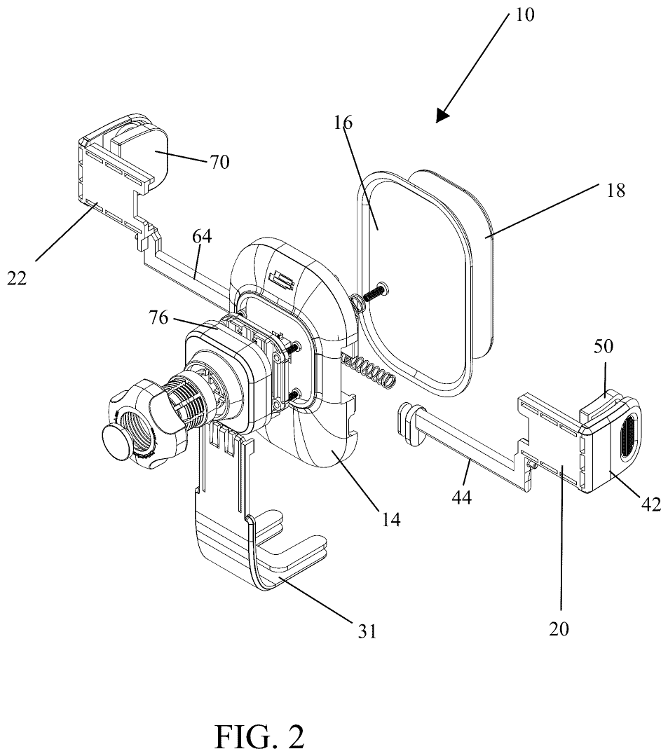

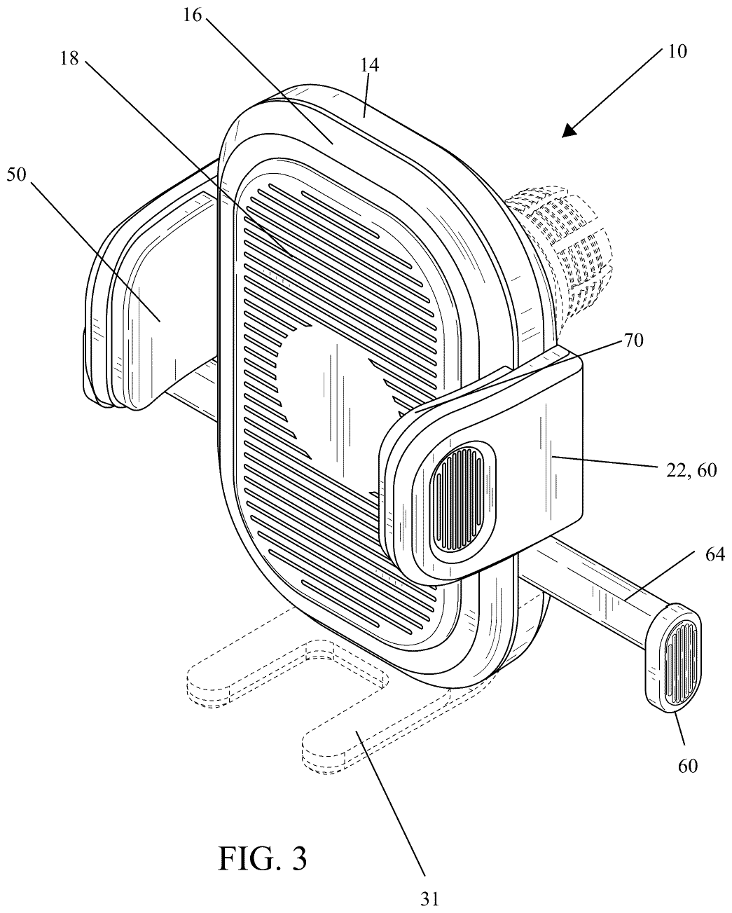

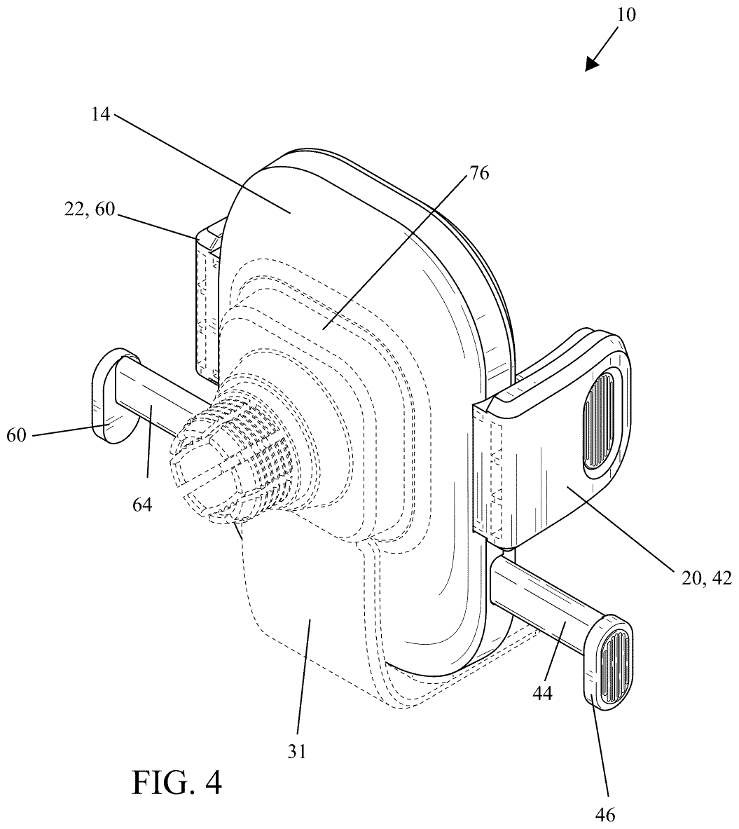

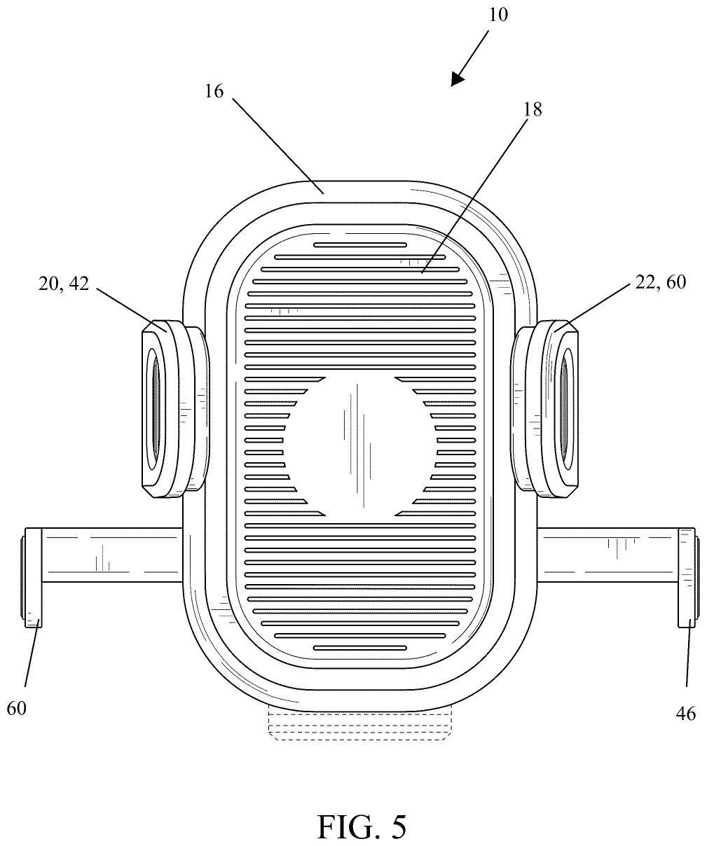

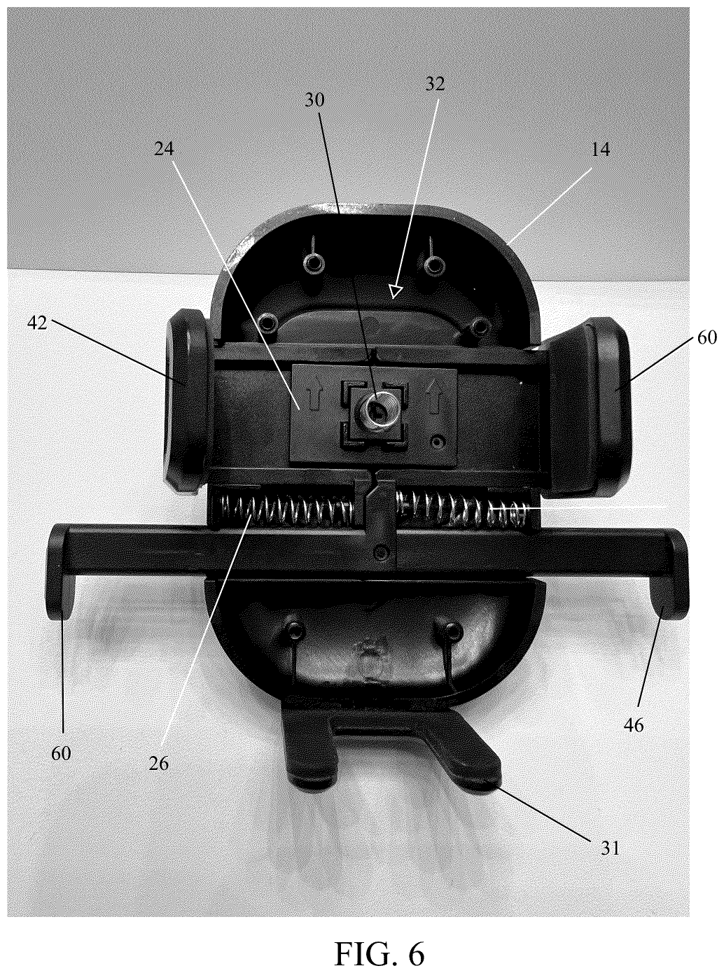

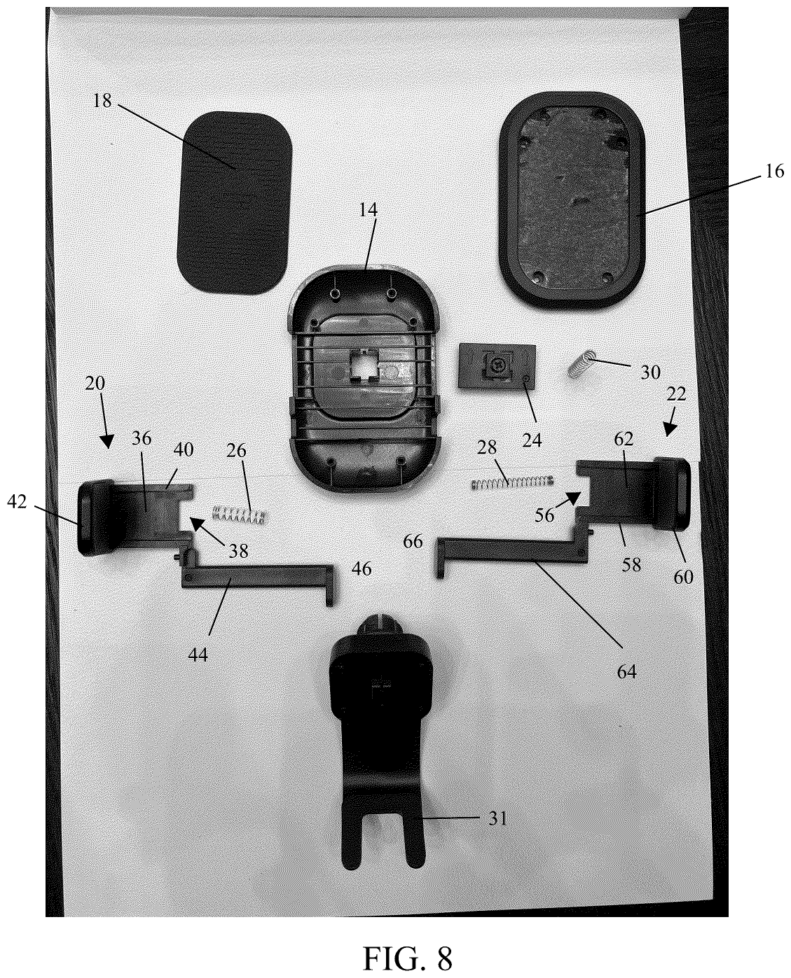

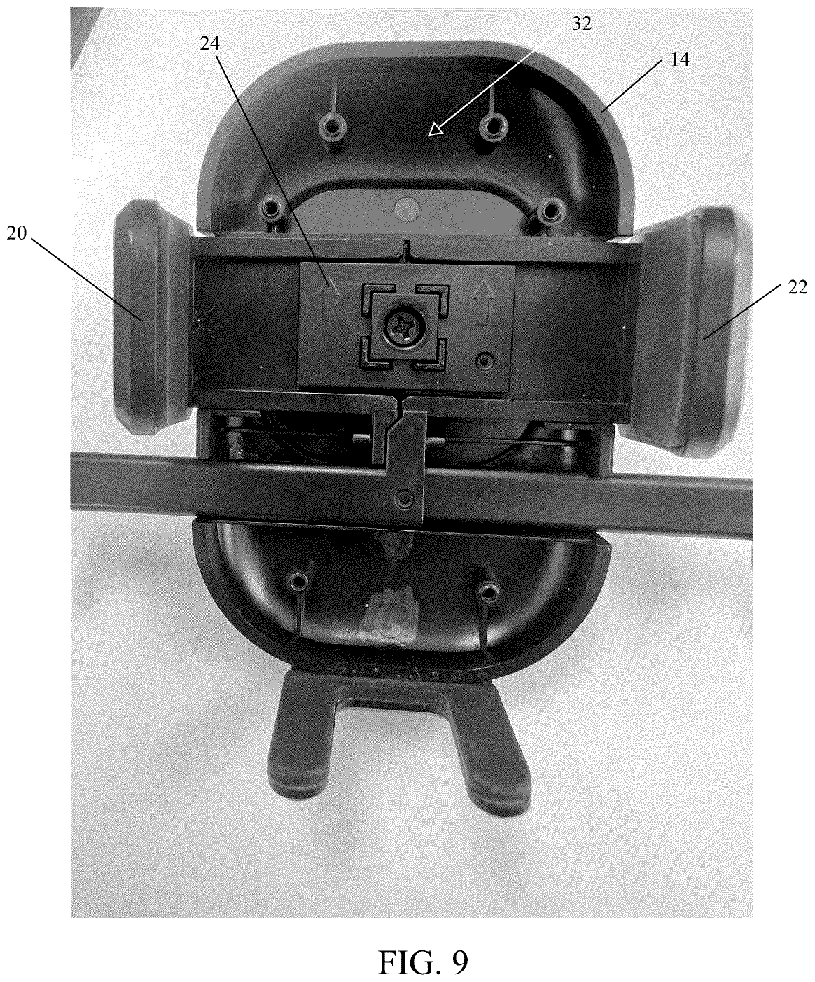

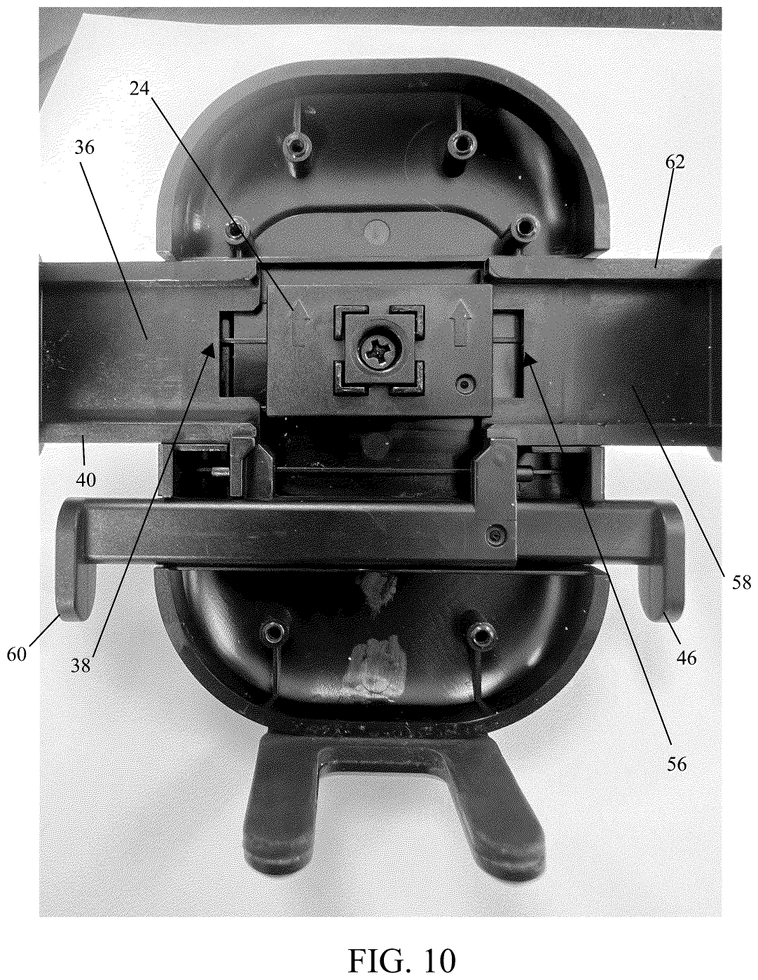

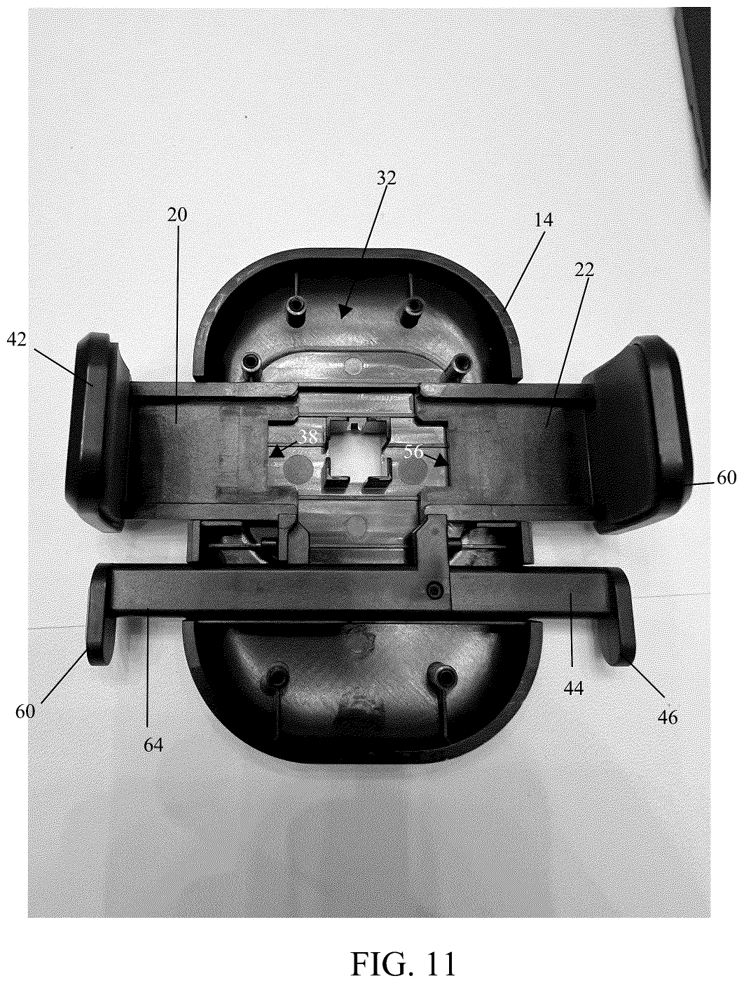

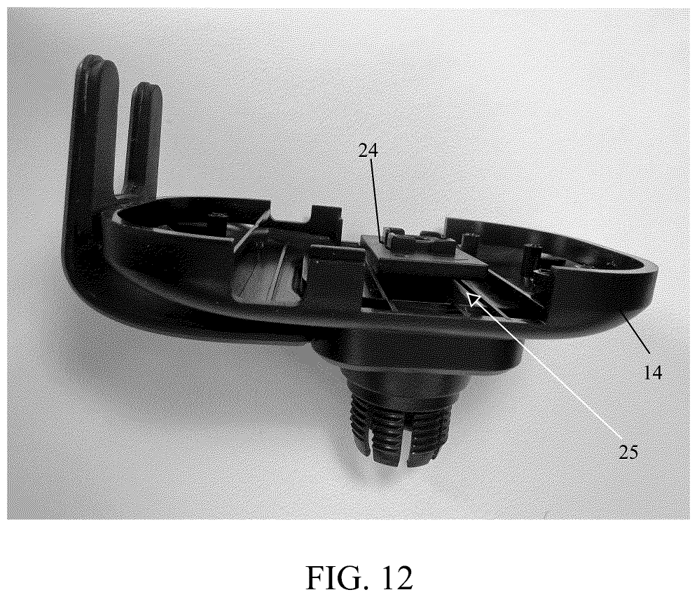

With reference now to the drawings and in particular FIGS. 1-13, embodiments of a phone mount of the present disclosure, which is generally designated by reference numeral 10.

As illustrated in FIGS. 1-13, the present disclosure is directed to a phone mount 10 that is configured to secure a phone to the mount 10 with a whole-body trigger allowing for one-handed grip.

The phone mount 10 generally includes a housing 12 comprising a main body 14, a cover plate 16 fixable to the main body 14, a pad 18 that is configured to extend over the cover plate 16 and be fixable thereto, a first arm 20, a second arm 22, a moveable plate 24, a first spring 26, a second spring 28 and a third spring 30 and a foot rest 31. The springs 26, 28, 30 are compression springs. The first arm 20 and the second arm 22 are configured such that one of the arms 20, 22 can extend over the other of the arms 20, 22.

The main body 14 includes a cavity 32. The moveable plate 24, first arm 20, second arm 22 and springs 26, 28, 30 are arranged at least in part within the cavity 32.

The first arm 20 includes a body 34 that has a base 36, which includes a recess 38 and sidewalls 40, a contact arm 42 that extends from the base 26, a leg 44 that extends at a first end thereof from the base 36 in a direction opposite the contact arm 42 and a release arm 46 that extends from a second end of the leg 44. A projection 48 extends from the first end of the leg 44. A contact pad 50 can be fixed to the first arm 42. The pad 50 can both provide added friction to aid in preventing a phone from sliding and to protect the phone from damage from contact with a hard surface. The first spring 26 is arranged within the cavity 32 in contact at one end with a sidewall of the main body 14 and the first spring 26 extends over the projection 48, which aids to orientate the spring 26 and ensure the spring 26 remains in contact with the first arm 20.

The second arm 22 includes a body 52 that has a base 54, which includes a recess 56 and sidewalls 58, a contact arm 60 that extends from the base 62, a leg 64 that extends at a first end thereof from the base 54 in a direction opposite the contact arm 60 and a release arm 66 that extends from a second end of the leg 64. A projection 68 extends from the first end of the leg 64 to aid in securing an end of the first spring 26. A contact pad 70 can be fixed to the contact arm 60. The pad 70 can both provide added friction to aid in preventing a phone from sliding and to protect the phone from damage from contact with a hard surface. The second spring 28 is arranged within the cavity 32 in contact at one end with a sidewall of the main body 14 and the second spring 28 extends over the projection 68, which aids to orientate the spring 28 and ensure the spring 28 remains in contact with the second arm 22.

The main body 14 includes a housing 72 in which the base 74 of moveable plate 24 is arranged. The moveable plate 24 is fixed to a rear housing 76 that is arranged on the external surface of the rear of the main body 14. Together, the moveable plate 24 and the housing 76 can move forward or away from the front of the main body 14 and backwards or toward the rear of the main body 14.

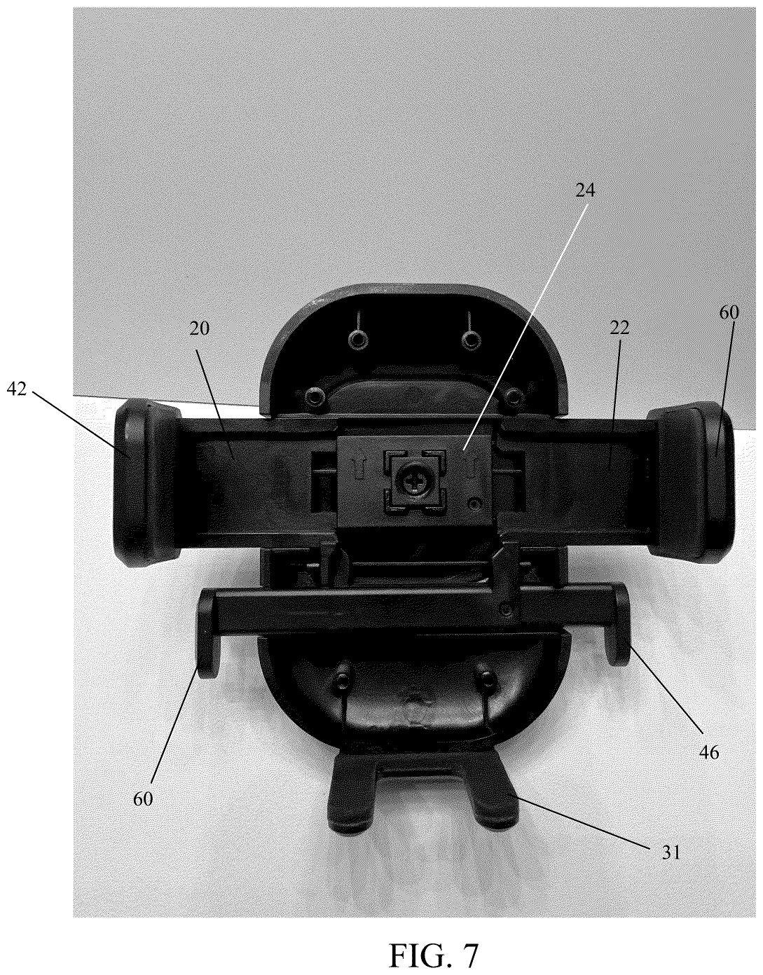

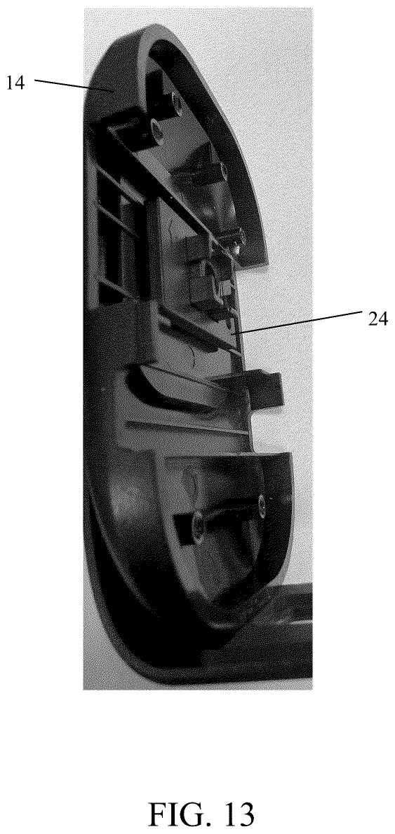

In a non-use state, the contact arm 42 of the first arm 20 and the contact arm 60 of the second arm 22 are spaced away from each other. The leg 44 and the leg 64 are contacted substantially within the cavity 32 and in turn, the release arm 46 and the release arm 66 are in close proximity to the main body 14 and between the contact arms 42, 60 (see FIG. 7). The first spring 26 and the second spring 28 are in a compressed state. The third spring 30 is in contact with the moveable plate 24 with the moveable plate 24 in contact with the main body 14 such that a gap does not exist between the moveable plate 24 and the main body 14 (see FIG. 13). By being in contact with the main body 14, the arms 20, 22 are prohibited from moving toward each other.

In a use state, the pad 18 and in turn cover plate 16 are contacted by a force (e.g. the back a phone). The force acts as a trigger to cause the moveable plate 24 to move away from the main 14 creating a gap 25 which in turn allows the first arm 20 and the second arm 22 to move toward each other with the aid of the first spring 26 band the second spring 28 to provide forces to the arms 20, 22. The base 36 of the first arm 20 slides under the moveable plate 24 with the recess 38 contacting the base 74 of the moveable plate 24 and the sidewalls 40 of the arm 20 aiding to guide and partially encompass the moveable plate 24 and the base 54 of the second arm 22 slides under the moveable plate 24 with the recess 56 contacting the base 74 of the moveable plate 24 and the sidewalls 58 of the arm 22 aiding to guide and partially encompass the moveable plate 24. When the arms are in a contracted or use state, the arm 20, 22 can secure a phone in place by exerting a force on each side of the phone.

To release a phone from the arms 20, 22, a user can use one-hand contact and apply a force to the outer surface of the release arm 46 and the release arm 66. This in turn causes the contact arm 42 and the contact arm 60 to become spaced away from or disengaged from the phone or device. When the release arms 46, 66 are fully contracted and the contact arms 42, 60 are fully spaced from each other, the moveable plate 24 can move toward the inner surface of the main body 14 and prevent the contact arms 42, 60 from moving toward each other.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A phone mount, comprising:
a housing;
a first arm arranged in part within the housing;
a second arm arranged in part within the housing;
a moveable plate movably fixed within the housing;
a first spring arranged within the housing and configured to interact with the first arm;
a second spring arranged within the housing and configured to interact with the second arm; and
a third spring arranged within the housing and configured to interact with the moveable plate.

2. A method of securing a device to a phone mount, comprising the steps of
providing a phone mount comprising a housing, a first arm arranged in part within the housing, a second arm arranged in part within the housing, a moveable plate movably fixed within the housing, a first spring arranged within the housing and configured to interact with the first arm, a second spring arranged within the housing and configured to interact with the second arm and a third spring arranged within the housing and configured to interact with the moveable plate;
contacting the housing with the device which in turn causes the first arm and the second arm to move in opposite directions and contact the device to secure the device within the phone mount.
